(19) United States
(12) Patent Application Publication
(10) Pub. No.: US 2007/0006160 A1
(43) Pub. Date: Jan. 4, 2007

(54) Software digital fingerprint

(76) Inventors: Sue Kunz, Boulder, CO (US); Alex King, Denver, CO (US); Emilio Suarez, Niwot, CO (US); Ahmad Zandi, Morgan Hill, CA (US)

Correspondence Address: HOLME ROBERTS & OWEN, LLP, 299 SOUTH MAIN, SUITE 1800, SALT LAKE CITY, UT, 84111, US

(21) Appl. No.: 11/479,418

(22) Filed: Jun. 29, 2006

Related U.S. Application Data
(60) Provisional application No. 60/695,837, filed on Jun. 29, 2005.

(51) Int. Cl. G06F 9/44

(52) U.S. Cl. 717/124

(57) ABSTRACT

A system and method for intelligently automating a software test process is disclosed. The present invention applies a data-driven approach coupled with statistical analysis and numerical methods, to achieve test execution across the development life-cycle of a software program.

### RELATED APPLICATION

The present application claims priority under 35 U.S.C. §119 to U.S. Provisional Patent Application No. 60/695,837, filed Jun. 29, 2005, and entitled “Software Digital Fingerprint”.

### BACKGROUND OF THE INVENTION

1. Field of the Invention

The present invention is generally directed to software testing, and more particularly to a graphical representation of areas of scrutiny for a software program.

2. The Relevant Technology

Software systems continue to grow in size and complexity, yet traditional graphical representations of software systems tend to include only part of the story (i.e., dependency mapping). Yet many dimensions are important to truly understand software structure and associated code attributes. Applications include (but are not limited to) quality assessment, performance profiling, complexity analysis, code comparison for due diligence or intellectual property characterization. Traditional dependency mapping further results in large visual representations of a software system (generally 2-dimensional) which are very difficult to understand.

In view of the foregoing, it may be useful to provide methods and systems that facilitate the aforementioned and other difficulties. The foregoing examples of the related art and limitations related therewith are intended to be illustrative and not exclusive. Other limitations of the related art will become apparent to those of skill in the art upon a reading of the specification and a study of the drawings.

### BRIEF SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements. An embodiment by way of non-limiting example solves the problems described by generating unique multi-dimensional graphical representations of software systems. Digital fingerprinting technology depicts function level structural elements including relationships between functions and data structures, as well as function internal structure including cyclomatic complexity and statement types, etc. Also included is a focus oriented navigation mechanism which allows users to fly through the code while abstracting information which is currently not of relevance.

In one embodiment attributes are mapped to dimensions. As that term is used, attributes comprise user specified and tool generated descriptors including scalability, portability, reliability, maintainability, asynchronous computability or MT-ability, criticality, and relative intellectual property value. Attribute may also include structural descriptors such as number of lines of code (LOC), comment to LOC ratios, cyclomatic complexity, relative risk of failure and risk type (e.g., security, portability, concurrency). In addition, run-time attributes such as performance profile, application footprint, memory utilization, transaction speed, test code coverage (branch and line level), etc may also be used. Additional attributes may comprise historical descriptors include owner(s), # of times modified, # of modifiers, cumulative number of defects, demographics, etc. Dimensions comprise icon shape, color, size, translucency; position (absolute and relative) and name (function, data structure, file); directional relationships as depicted by connectors, connector color.

In another embodiment, a configurable mouse over textual data retrieval for attributes and descriptors is provided. A user simply moves the mouse pointer over a particular item of interest, and the associated attributes are displayed graphically.

In yet another embodiment, point and click navigation based upon function of primary interest (e.g., module of interest is center icon with surrounding icons representing control or data relationships) is provided. Attribute based navigation (e.g., display all functions written by programmer x, or all functions which currently have potential defects) may also be utilized in accordance with another aspect of the present invention

In still another embodiment of the present invention, identification of relevant information not depicted (currently implemented via icon shadows) may be used. In such an arrangement, the information that is currently not of interest is graphically represented differently than the information of interest. For example, the item might be shadowed such that the user can still see the item, however, it is graphically represented differently than the item of interest to quickly ascertain what is currently relevant and irrelevant for the interested parameters.

Pattern matching across code bases may be provided that identify code structures which have fundamentally the same internal structure—indicating the segments are the same code or almost the same code even if minor modifications such as name changes or packaging have been changed.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 illustrates a functional view of a C-language application having associated projects, in accordance with an exemplary embodiment;

FIG. 2 illustrates the functional view of one project associated with the C-language application in FIG. 1;

FIG. 3 illustrates a further functional view of the project associated with FIG. 2 that is centered as a current focal point, in accordance with an exemplary embodiment;

FIG. 4 illustrates a matrix tool from the drop-down menu that abstracts currently relevant information associated with risk, coupling, complexity and volume that is displayed using a mouse-over display in accordance with an exemplary embodiment;

FIG. 5 illustrates a filtering mechanism to abstract currently irrelevant information, in accordance with an exemplary embodiment;

FIG. 6 illustrates a mouse over display for a particular node illustrating metrics as well as hierarchical information associated with the selected node, in accordance with an exemplary embodiment;

FIG. 7 illustrates the removal of nodes that are no of interest after utilizing the filtering mechanism of FIG. 5.

FIG. 8 is a block diagram of an embodiment of a network, such as the Internet which may be associated, for example with a C-1 language application; and

FIG. 9 is a block diagram of an embodiment of a computer that can be used as a client computer system or a server computer system or as a web server system with, for example, a network system of FIG. 8.

### DETAILED DESCRIPTION OF THE PREFERRED EMBODIMENTS

A system and method for intelligently automating a software test process is disclosed. The present invention applies a data-driven approach coupled with statistical analysis and numerical methods, to achieve test execution across the development life-cycle of a software program. The data comprises user-provided configurations, priorities and code criticality assessment, probability of failure as determined by the tool, as well as empirical data to make intelligent choices including “what needs to be tested,” where it will test” and “when it will be tested.”

By focusing available test resources on “code at risk” and “code that matters” without compromising code coverage, time-to-defect-discovery is decreased. Such test resources will enable continuous, life-cycle-based software testing, thereby reducing the cost and effort required to identify and fix defects. Defects will be fond as they are introduced, allowing developers to spend more time on the creative aspects of software development. As that term is used herein, defect means any undesirable and unexpected behavior as perceived by the user or non-compliance with a particular need. For example, a defect may include any undesirable and unexpected behavior of the software system as perceived by the customer. This might include functional errors (e.g., incorrect results, code crashes to name a few) or violation of attribute boundary conditions (e.g., expected performance, resource utilization such as memory, CPU cycles, footprint). Defects may also include non-compliance with business needs, such as violation of coding standards which might result in poor software portability or maintainability, code complexity reducing understanding and maintainability and security vulnerability to name a few.

The present invention also provides a code and test suite assessment. Such an arrangement assists engineering and product management in making better decisions with respect to resource allocation, product readiness and expected field failure rates.

The user should be able to traverse the graphical interface from the highest level all the way to source instructions, and be presented with information along the way.

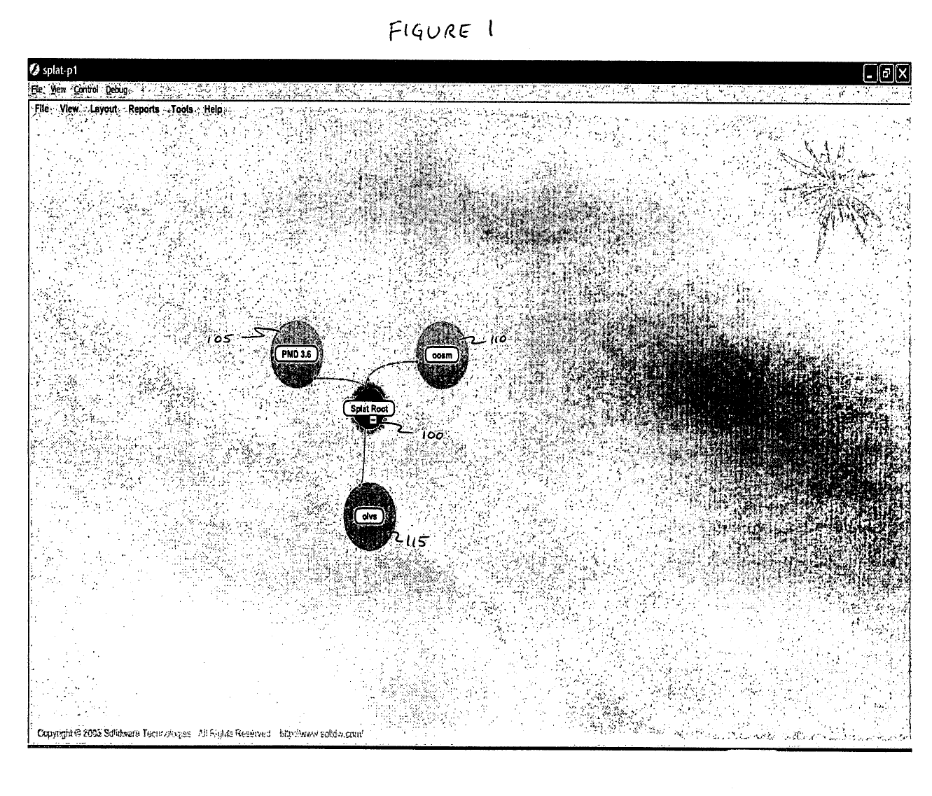

FIG. 1 illustrates a functional view of a C-language application 100, in accordance with an exemplary embodiment. In accordance with the present invention, a software program is analyzed by introducing code into application 100 to produce a project. Projects 105, 110, 115 are graphical representations of various software products that have been analyzed by application 100 and stored for retrieval by a user.

There are various representations that display information graphically that quickly inform a user of the underlying information associated with a particular graphical Icon color represents where the code originated from (file, library, system call, etc.) Size represents number of lines of code. Translucency is mapped to cyclomatic complexity. Connectors map control relationships with the circular connector terminator indicating the child and the end without terminator indicating the parent. The shadow indicates that not all information of relevance could be displayed for this particular view given the current view settings (i.e., number of tiers displayed).

Cyclomatic complexity and other complexity metrics as that term is used herein, measures the number of linearly-independent paths through a program module. This measure provides a single ordinal number that can be compared to the complexity of other programs. Cyclomatic complexity is also referred to as program complexity or as McCabe's complexity.

Application 100 comprises a module that provides a graphical interface with navigation mechanics to allow a user to view the various hierarchical levels of a software design. In addition, a code view may be provided to show the corresponding source code of interest. color coding may also be provided to identify the severity of any detected code quality issues. In addition, application 100 identifies the risk index, empirical data and criticality index used to determine which code components require the most scrutiny.

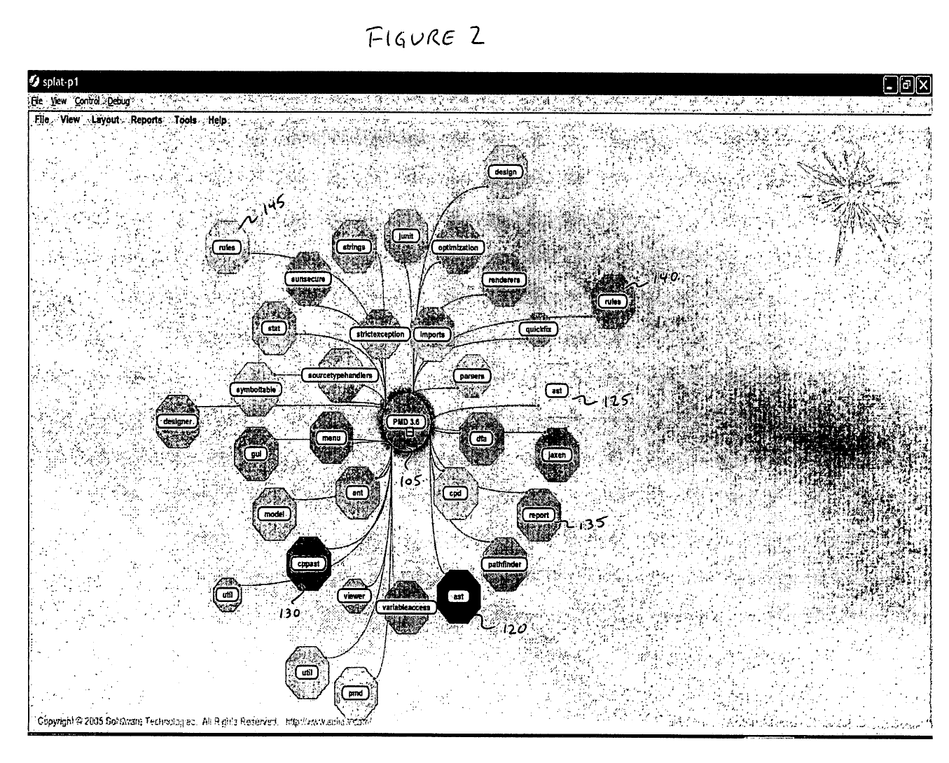

FIG. 2 illustrates the functional view of one embodiment of a project 105 associated with the C-language application in FIG. 1. The graphical representation of project 105 shows various classes and methods illustrating the interaction between software products, such as the use of code or data from an associated node.

In the embodiment illustrated in FIG. 2, color designation of classes 125, 130, 135 illustrate the amount of risk associated with each of the classes. In the illustrated embodiment, class 120 is a deep red color indicating a high amount of risk. Continuing with the illustrated embodiment, class 130 is a lighter red color than class 120, thereby indicating an amount of risk that is lower than class 120. Also shown, class 125 is a very light green indicating a very small amount of risk associated with that particular class. Accordingly, the graphical representation displayed to the user can quickly show where certain classes should be further examined to evaluate the associated risk.

Project 105 has various classes associated, and the graphical representations are illustrated with the connector lines. For example, classes “rules” 140 and “rules” 145 are associated with project 105, and accordingly a line is drawn from both rules 140 and rules 145 to project 105 showing this affiliation. The graphical view of this affiliation may be referred to as a membership view, since it shows what belongs to what. This level illustrates each of the classes that are associated with project 105. In addition, the shape of the various classes indicate hierarchical relationship. In the illustrated embodiment, rules 140 is an octagon, which indicates, in this embodiment, a high level class.

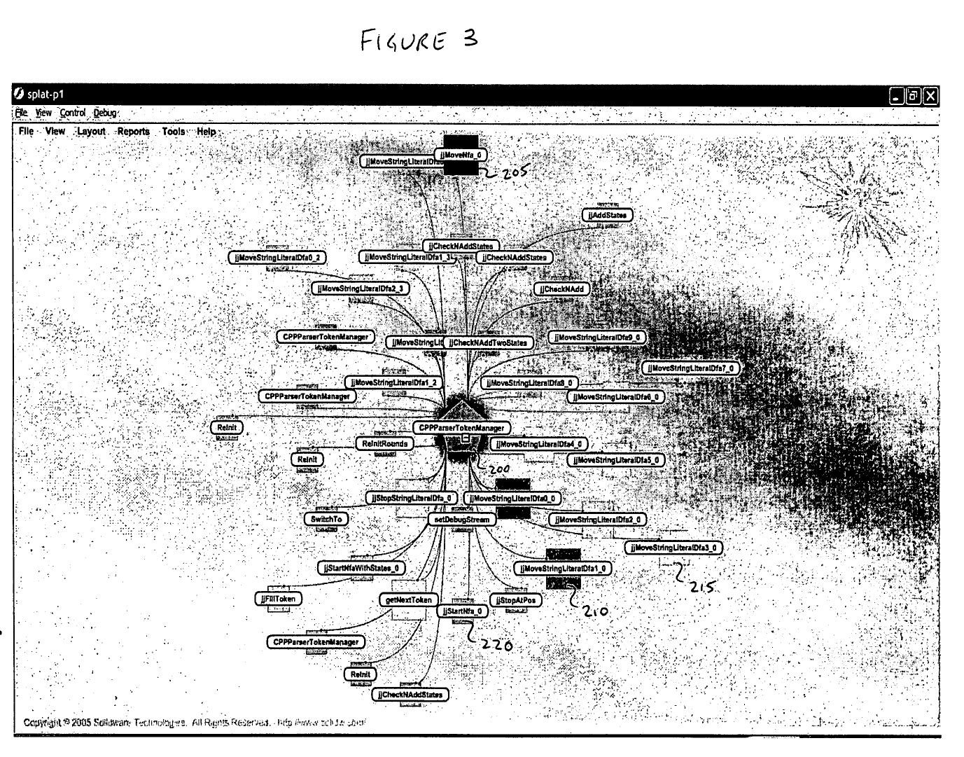

FIG. 3 illustrates a detailed view of a class CPPParser Token Manager 200, which is part of project 105, but lower in the hierarchical scheme than the classes shown in FIG. 1. Again, this fact is evident from the shape of the CPPParser Token Manager 200, which in this case is a pentagon. In addition, functions and relationships previously not displayed are now visible in agreement with the current digital fingerprint settings. A feature of the display capability of the embodiment is number of tiers of parent/child/grandchild/grand-grandchild etc. relationships can be specified by the user.

As illustrated, there are certain classes that are of interest based upon its associated color. For example, a class jjMoveNfa_{—}0 205 is illustrated as red in color, thus indicating to a user that this class would be of interest to examine further since it poses a fair amount of risk.

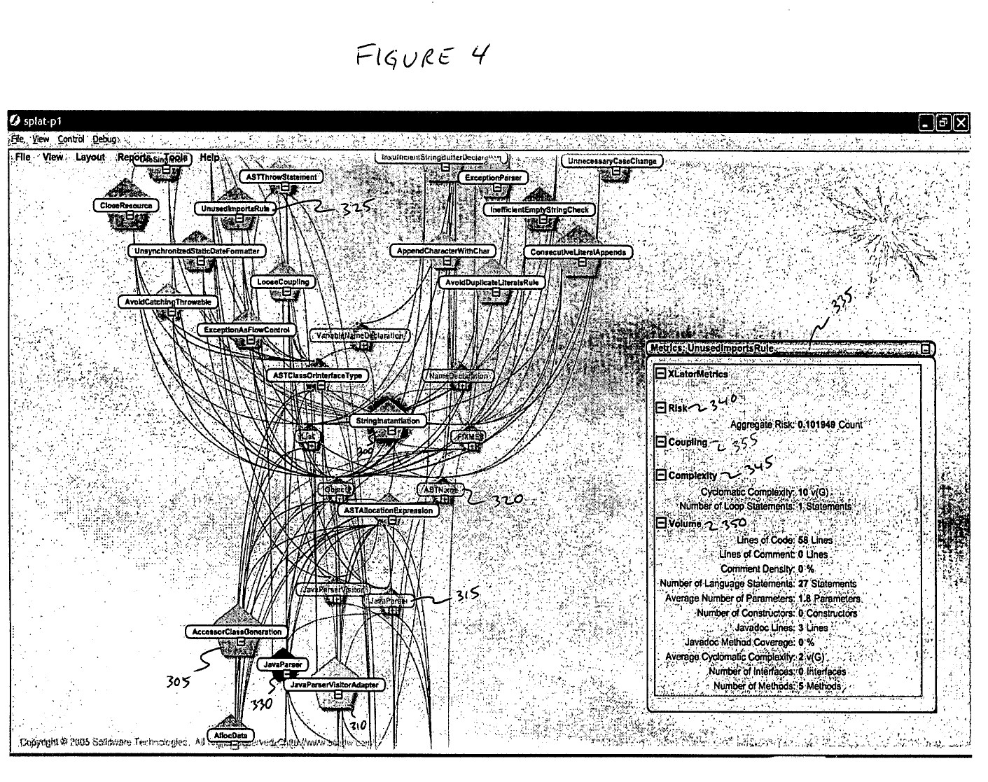

FIG. 4 illustrates a metrics view 335 of a particular class UnusedImportsRule 325. The metrics view 335 is configured to show the aggregate value of risk 340, the cyclomatic complexity 345, the coupling 355 and the volume 350 for various classes illustrated. In the illustrated embodiment, the metrics for UnusedlmportsRule 325 is shown. The metrics view is user configurable from the drop-down menus.

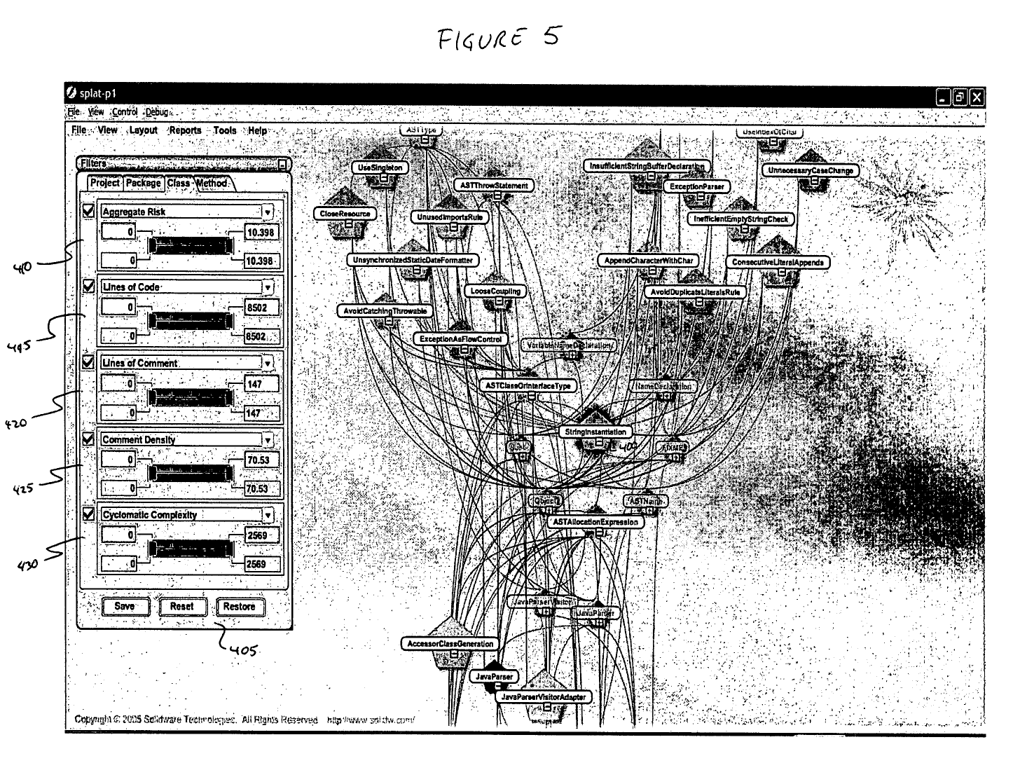

FIG. 5 illustrates a filtering mechanism 405 to abstract currently irrelevant information, in accordance with an exemplary embodiment. The filtering capability is shown with current filters tied to aggregate risk 410, lines of code 415, lines of comment 420, comment density 425 and cyclomatic complexity 430. Similar to FIG. 4, attribute to filter mapping is user configurable.

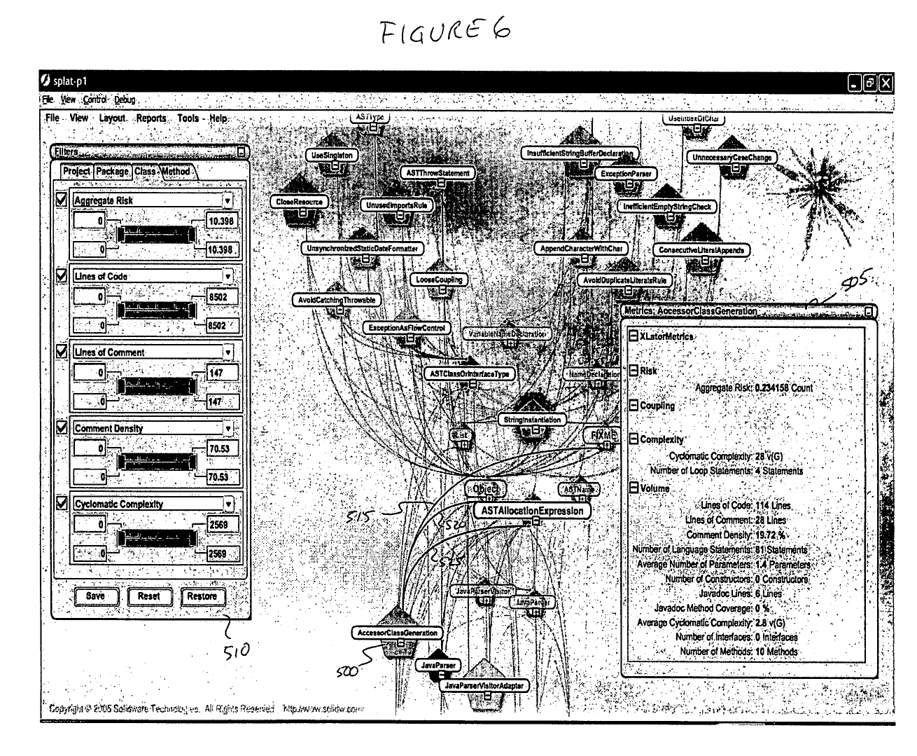

FIG. 6 illustrates a mouse over display for a particular node illustrating metrics as well as hierarchical information associated with the selected node, in accordance with an exemplary embodiment. In addition, the filter 510 and the metrics 505 associated with the AccessorClassGeneration 500 is also shown.

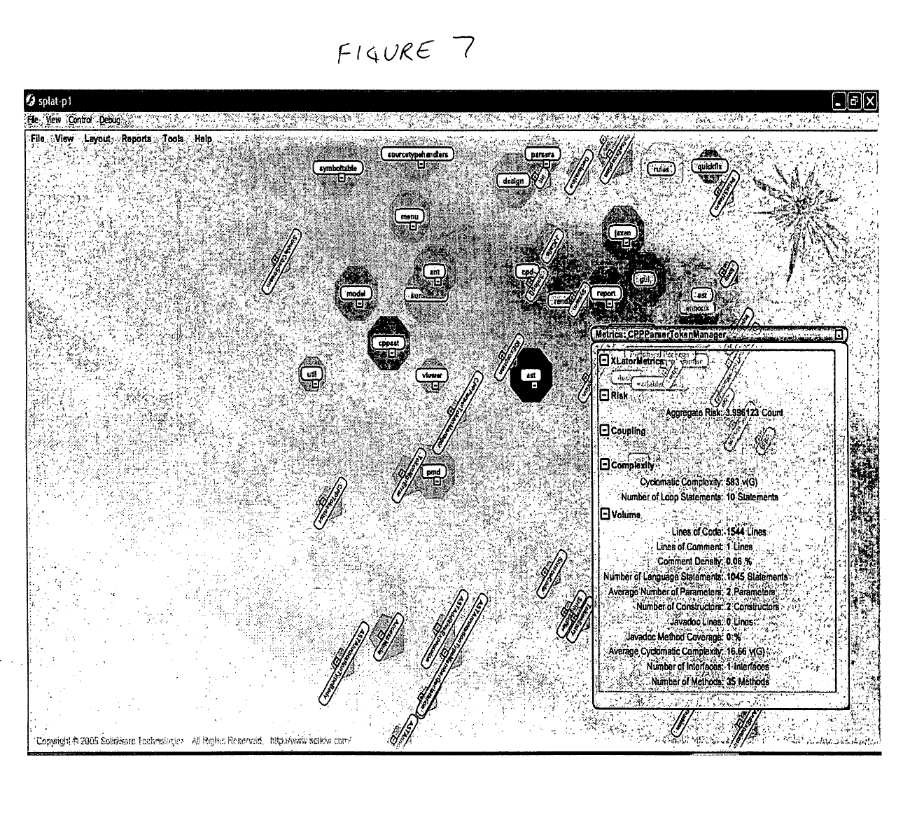

FIG. 7 illustrates a refresh mode where all non-important information is removed from the graphical display and only the items of interest remain in view. Such a view makes it easier for the user to examine items of interest without the other items that are not of interest on the screen.

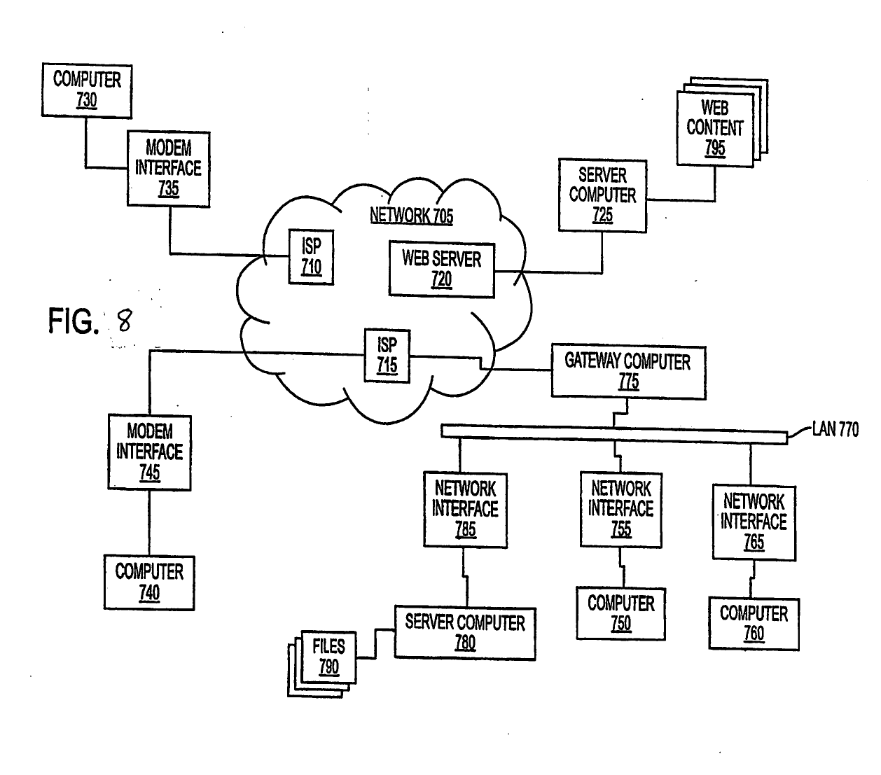

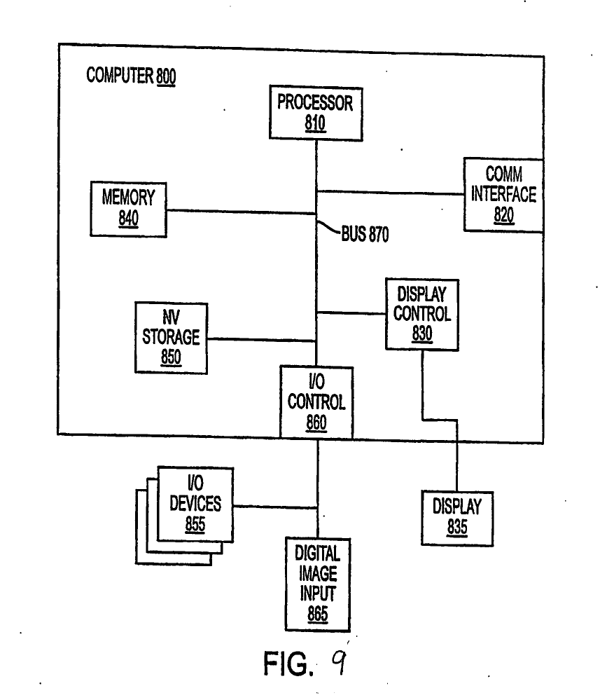

The following description of FIGS. 8-9 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and digital audio receivers that may receive digital radio broadcasts from a satellite and the like. The invention can also be practiced in distributed computing environments where tasks are performed by remote processing devices that are linked through a communications network.

FIG. 8 is a block diagram of an exemplary embodiment of a network 705, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 705 is typically provided by Internet service providers (ISP), such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the World Wide Web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, a Web TV system, or other such computer system.

Similarly, the ISP 715 provides Internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, ISDN modem, cable modem, satellite transmission interface (e.g. “Direct PC”), or other interfaces for coupling a computer system to other computer systems.

Client computer systems 750 and 760 may be coupled to a LAN 770 through network interfaces 755 and 765, which can be Ethernet network or other network interfaces. The LAN 770 is also coupled to a gateway computer system 775 which can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 9 is a block diagram of an exemplary embodiment of a computer that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, ISDN modem, cable modem, token ring interface, satellite transmission interface (e.g. “Direct PC”), or other interfaces for coupling a computer system to other computer systems.

The computer system 800 includes a processor 810, which can be a conventional microprocessor such as an Intel Pentium microprocessor or Motorola Power PC microprocessor. Memory 840 is coupled to the processor 810 by a bus 870. Memory 840 can be dynamic random access memory (DRAM) and can also include static RAM (SRAM). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to this embodiment, but it may lack some of the features shown in FIG. 7, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

We claim:

1. A method for graphically displaying information associated with a test process of a software product, said method comprising:
introducing said software product having a plurality of lines of code, said lines of code associated with a plurality of classes and methods;
applying rules to said software product to analyze said lines of code in accordance with parameters so as to return information associated with said lines of code; and
graphically displaying said information associated said lines of code.

2. The method of claim 1, further comprising holding a mouse icon over a graphical representation of one of said plurality of classes and methods to display said information associated with said lines of code associated with said one of a plurality of classes and methods.

3. The method of claim 2, wherein said information comprises membership information describing any other classes and methods that are associated with said one of said plurality of classes and methods.

4. The method of claim 2, wherein said information comprises reference information describing interaction with any other classes and methods that are associated with said one of said plurality of classes and methods.

5. The method of claim 4, wherein said interaction comprises accessing code from a class or method.

6. The method of claim 4, wherein said interaction comprises receiving data from a class or method.
